(19) United States
(12) Patent Application Publication
(10) Pub. No.: US 2004/0098309 A1
(43) Pub. Date: May 20, 2004

(54) Communication device

(76) Inventors: Clive Smeardon, Hampshire (GB); John Charles Ash, Hampshire (GB); Philip Michael William Ireland, Hampshire (GB); John Alan Skinner, Hampshire (GB)

Correspondence Address: Oliff & Berridge, PO Box 19928, Alexandria, VA, 22320, US

(21) Appl. No.: 10/471,872

(22) PCT Filed: Mar. 8, 2002
(86) PCT No.: PCT/GB02/01065

(30) Foreign Application Priority Data
Mar. 14, 2001 (GB) 0106289.2

(51) Int. Cl. G06G 1/12

(52) U.S. Cl. 705/21

(57) ABSTRACT

A communication device (7) for interfacing cash handling apparatus (1-4) to a communications network (5). The device (7) comprises a processing system (11) for converting data received from either a communications network (5) or cash handling apparatus (1-4) to which the device is connected into a format suitable for transmission to its destination. The processing system (11) is provided on a support (8) which can be located in or on the cash handling apparatus.

The invention relates to a communication device for interfacing cash handling apparatus to a communications network.

Cash handling apparatus can take a variety of forms depending upon the nature of the handling operations which are to be performed. Examples of known cash handling apparatus include coin and currency sorters, acceptors and dispensers as well as currency recirculators and the like. Conventionally, these device have been stand-alone but more recently there has been a need to interface the devices, typically in a small cluster, with a wide area network either proprietary or public (such as the Internet). Up to now, this has been achieved by coupling the controller of each apparatus with a common PC which includes a network interface card or the like to enable data to be communicated to a communications network.

The problem with this approach is the need for a PC to 20 provide the link to the wide area network and the limited data which has been transferred. With the associated cost, physical size and overheads involved, PCs with their associated components (keyboard, mouse) lack physical robustness, are not user “fiddle-proof” and not secure from attack using known methods when used in the application environment.

In the field of vending machines, it is known to provide a communication system for passing data relating to the performance of the vending machine to a remote supervisor but this limited communication ability is of little use in the field of cash handling apparatus. Examples of vending machines of this type are described in WO-A-99/23620, U.S. Pat. No. 4,766,548 and FR-A-2755776.

In accordance with the present invention, we provide 35 a communication device for interfacing cash handling apparatus to a communications network, the device comprising a processing system for converting data received from either a communications network or cash handling apparatus to which the device is connected into a format suitable for transmission to its destination characterised in that the processing system is provided on a support which can be located in or on the cash handling apparatus.

We have devised a new type of communication device, conveniently referred to as a “node”, which can be provided at low cost compared to the previous use of a PC and is small and easy to install so that it can be fitted to any coin or currency device which has a need to communicate to other products and importantly can receive data from the communications network as well as pass data to the network.

The cash handling apparatus can be fitted easily with the node either in the factory or after supply to the user while avoiding the complexities of linking a controller of the apparatus to a PC.

The communication device can take a variety of forms but will typically comprise a printed circuit board and most conveniently, the processing system is fabricated on a single chip. This maximises the simplicity and low cost of the product.

The communication device may comprise a number of proprietary devices to provide the functionality required but could be condensed into a single device with external flash memory.

In some cases, the processing system includes a processor adapted solely to provide intercommunication between cash handling apparatus and at least one communications network.

This provides the ability to construct a very simple processor which leads to low cost and high speed data transfer between the apparatus and the communications network.

In other cases, however, the processing system includes a processor and a memory for temporary data storage, the processor being adapted, in some cases solely, to provide intercommunication between the cash handling apparatus to which it is coupled and at least one communications network and to access the memory for data storage and retrieval. In this case, some more sophisticated data processing is possible within the processor.

The communication device could be constructed so as to be suitable for use with a single communications network but for ease of manufacture, the processing system preferably includes software and/or hardware components to enable the device to communicate with more than one communications network. The node can be connected using any conventional physical connection and support protocols such as Ethernet—10 base 2 and 10 base T, USB (Universal Serial Bus), CAN (Controller Area Network), Firewire, Bluetooth and other wireless network standards, and POTS and ISDN.

Typically, the processing system is adapted to encode data for transmission in a secure manner and to decode received data. This is preferably achieved using a public/private key system.

The communication device has other advantages such as improving servicing since it will allow service engineers to interrogate a particular apparatus before a visit so as to determine the spare parts required while planned maintenance can be replaced with “just in time” and for many users this will extend the service intervals and hence reduce the cost of ownership.

As mentioned above, the invention is applicable to a wide variety of cash handling apparatus and can also extend to such apparatus for handling documents or tokens of significant value, bonds, vouchers, travellers cheques, casino chips, tax discs, postage stamps and the like.

The data that is transferred from the apparatus to the communications network may include data relating to the cash handling operations carried out by the apparatus such as total value of cash processed, details of individual cash items, diagnostic information and the like while data transmitted to the apparatus may include communication setup information, data to enable the apparatus to operate such as authentication data, denomination pattern information and the like, as well as software upgrades, bug fix data etc. In addition, operator activity or through put logging may be included which would require a login process. In most cases, the processing system will process raw data from the cash handling apparatus and transmit data representing the outcome of that processing.

In the most preferred examples, the communication device has the capability to download software from a host to enable updating of firmware operation, to add security, to fix code bugs, and to allow for the introduction of new issues of coins and notes. It also has sufficient intelligence to determine where a particular type of software should be located within a particular machine. Conveniently, the device also has access to an area of memory to provide storage for a number of software utilities and host web pages in Java or similar. This can store web page(s) or applets to enable the device (counter) to be remotely interrogated. The page(s) could hold machine data or format machine data in an appropriate sequence.

Some examples of arrangements of communication devices according to the invention will now be described with reference to the accompanying drawings, in which:-

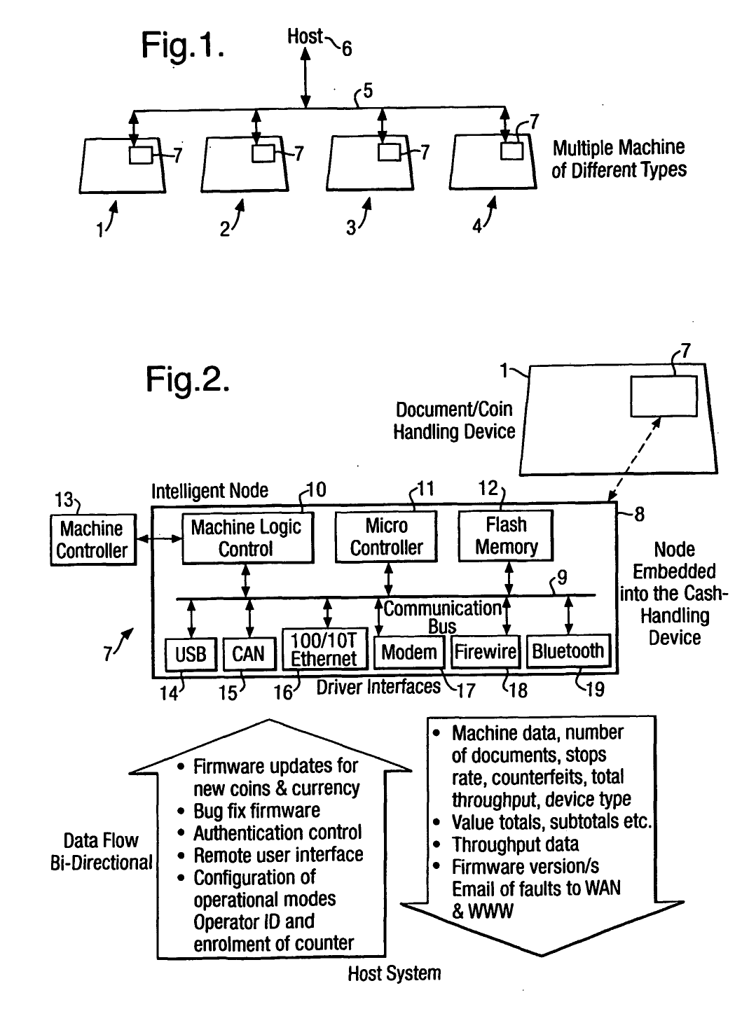

FIG. 1 is a block diagram illustrating a cluster of cash handling machines connected to a host via a wide area network;

FIG. 2 illustrates schematically the construction of one example of a node in more detail; and,

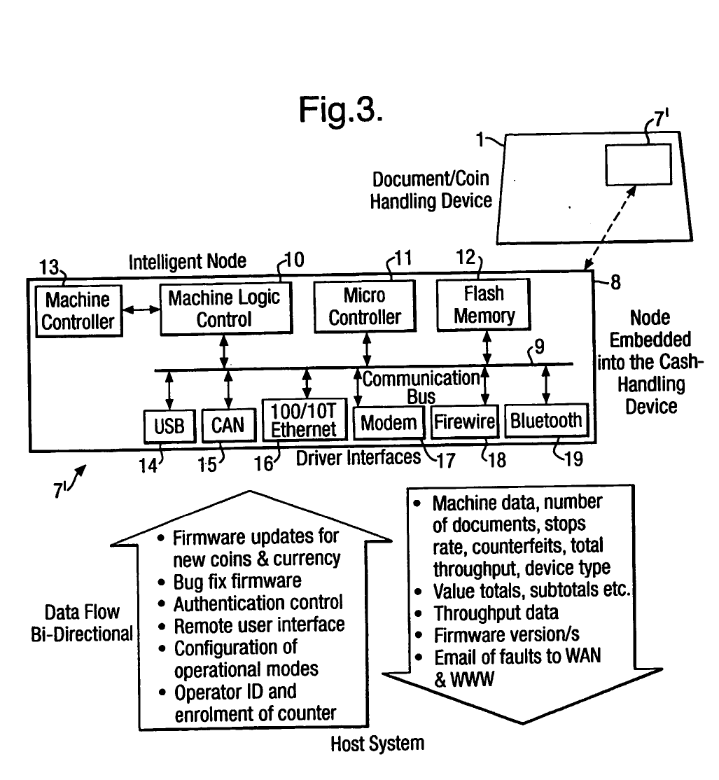

FIG. 3 is a view similar to FIG. 2 but of a second example.

The system shown in FIG. 1 comprises four cash handling machines 1-4 which are typically of the “desk top” type and may include banknote counters, banknote sorters and coin sorters. Of course, many other types of machine could also be used as described above. Typical examples of machines are the De La Rue 2700, 2800 banknote counters and the De La Rue Mach12 coin sorter. Each machine 1-4 is coupled via any known network connection link to a wide area network 5, such as the Internet, or PSTN system, to which a remote host 6 is also connected. In order to achieve interconnection between the wide area network 5 and the machines, each machine housing supports a node 7, the nodes 7 having an identical construction but being configured as necessary for communication with the machine to which they are attached.

FIG. 2 illustrates a typical example of a node construction in more detail. As can be seen in FIG. 2, the node 7 is provided on a PCB 8 and includes a communication bus 9 to which is connected machine logic control hardware and software 10, a microcontroller 11 and flash memory 12. The flash memory 12 may instead be any other non-volatile memory or storage such as EEPROM or battery backed RAM. The machine logic control hardware/software 10 communicates either via a CMS (Cash Management Software) port or via a TTL RS232 link with a machine controller 13 which will have a conventional form and will be dependent upon the machine in which it is provided.

The machine logic control hardware/software 10 is provided to enable the node 7 to interface with the machine controller 13 while the microcontroller 11 is necessary to run the node and to provide a level of flexibility dependent on the code located in the flash memory 12. Typically, the memory 12 will be split to enable it to be loaded with code for the node, data storage and slow operating working memory.

To enable communication with the wide area network 5, the node 7 also includes a set of hardware/software blocks 14-19 to enable the node to be connected by any one of a number, in this case six, means to the network.

In a typical processing operation, the machine controller 13 will cause cash such as currency banknotes in the machine to be fed past various detectors to one or more than one output receptacle. Tests will be carried out on information obtained from the banknotes so as to determine denomination, authenticity and the like in a conventional manner. In order to carry out those tests, the machine controller 13 will make use of prestored data relating to the expected banknotes including pattern data, size data, and data relating to the response of the banknotes to non-visible radiation.

The machine controller 13 will maintain a log of the currency handling process.

The presence of the intelligent node 7 enables information concerning the cash handling process to be communicated to the remote host 6. As shown in FIG. 2, this information can include machine data, number of documents, stop rate (i.e. the number on occasions on which the machine stops due to the presence of an unidentified note), details relating to counterfeits, total throughput, device type, man machine interface information and the like. In addition, the information can include total value of currency handled, subtotals etc., throughput data, details relating to firmware version(s) within the machine controller 13 and, where the machine controller 13 includes diagnostic software, details of faults in the form of email communications. Throughput data may include number of notes, number of denominations, number of times the machine has stopped, number of operator interventions, number of supervisor interventions, number of counterfeit documents detected, level of confidence in the counterfeit detection level, detector set up level, throughput level, operation mode etc. i.e. a full mirror of the capability of the user interface, man machine interface. The host 6 will monitor the received data and can thus act as a remote user interface.

The data will be encoded by the controller 11 in a secure manner, for example using a public/private key.

The node 7 can also receive data from the host 6. Data sent from the host 6 can include firmware updates, for example data relating to new coins or currency which are to be handled by the machine, bug fix firmware, authentication control data for example, master pattern template, authentication data, i.e. the firmware that holds master information, configuration of operational modes, and operator ID and enrolment information. Again, this data will be encoded by the host 6 and decoded by the controller 11.

In order that the data can be targeted from the host to the correct machine, each machine will have a unique address which can either be manually assigned or preferably automatically set up by the node 7. This can be done by an auto-assignment technique (according to the network type e.g. such as DHCP in the case of TCP/IP networks) or a manual address setting that is appropriate for the host network.

Further integration of the node is possible, as shown in FIG. 3. In this example, a node 7′ is the same as the node 7 in FIG. 2 but with the machine controller 13 integrated into the node.

1. A communication device for interfacing cash handling apparatus to a communications network, the device comprising a processing system for converting data received from either a communications network or cash handling apparatus to which the device is connected into a format suitable for transmission to its destination characterised in that the processing system is provided on a support which can be located in or on the cash handling apparatus.

2. A device according to claim 1, wherein the support comprises a printed circuit board.

3. A device according to claim 1 or claim 2, wherein the processing system is fabricated on a single chip.

4. A device according to any of the preceding claims, wherein the processing system includes a processor adapted solely to provide intercommunication between cash handling apparatus and at least one communications network.

5. A device according to any of claims 1 to 3, wherein the processing system includes a processor and a memory for temporary data storage, the processor being adapted solely to provide intercommunication between the cash handling apparatus to which it is coupled and at least one communications network and to access the memory for data storage and retrieval.

6. A device according to any of the preceding claims, wherein the processing system includes software and/or hardware components to enable the device to communicate with more than one communications network.

7. A device according to claim 6, wherein the software and/or hardware components communicate with communication networks via one or more of: Ethernet, USB, CAN, Firewire, Bluetooth, POTS and ISDN.

8. A device according to any of the preceding claims, wherein the processing system is adapted to communicate with cash handling apparatus via a CMS (Cash Management Software) port or via a TTL RS232 link.

9. A device according to any of the preceding claims, wherein the processing system is adapted to generate a unique network address.

10. A device according to any of the preceding claims, wherein the processing system is adapted to decode encoded data received from the communications network.

11. Cash handling apparatus including a communications device according to any of the preceding claims.

12. Cash handling apparatus according to claim 11, wherein the apparatus is adapted to handle currency or coins.

13. Apparatus according to claim 12, wherein the apparatus is one of a sorter, acceptor, dispenser, recirculator, and counter.

14. Apparatus according to any of claims 11 to 13, wherein the processing system is adapted to pass information concerning each item of cash handled by the cash handling apparatus to the communications network.

15. Apparatus according to claim 14, wherein the information includes one or more of the denomination, authenticity, and orientation of the item of cash.

16. Apparatus according to any of claims 11 to 15, wherein the processing system is adapted to pass one or more of the following items of information to the communications network: information relating to a cash handling operation, diagnostic information, communication-set-up information, and operation of MMI (Man Machine Interface).

17. Apparatus according to any of claims 11 to 16, wherein the processing system is adapted to pass one or more of software upgrades, code bug fixes, and data enabling the cash handling apparatus to handle new items of cash to the cash handling apparatus.

18. A cash handling system comprising a plurality of cash handling apparatus according to any of claims 11 to 17, the communication devices of the apparatus being connected to a host device via a communications network.

19. A cash handling system according to claim 18, wherein the communications network comprises a wide area network such as the Internet, a satellite, cable, broadcast or PSTN system.
